(19) United States
(12) Patent Application Publication
(10) Pub. No.: US 2009/0297974 A1
(43) Pub. Date: Dec. 3, 2009

(54) CARRIER FOR AN ELECTROPHOTOGRAPHIC DEVELOPER, AND ELECTROPHOTOGRAPHIC DEVELOPER USING THE CARRIER

(75) Inventors: Takashi Kojima, Kashiwa-shi (JP); Tetsuya Uemura, Kashiwa-shi (JP); Tsuyoshi Itagoshi, Macsudo-shi (JP)

Correspondence Address: GREENBLUM & BERNSTEIN, P.L.C., 1950 ROLAND CLARKE PLACE, RESTON, VA, 20191, US

(73) Assignee: Powdertech Co., Ltd., Chiba (JP)

(21) Appl. No.: 12/410,650

(22) Filed: Mar. 25, 2009

(30) Foreign Application Priority Data
Mar. 26, 2008 (JP) 2008-080811

(51) Int. Cl. G03G 9/097; G03G 9/10

(52) U.S. Cl. 430/108.24; 430/111.1

(57) ABSTRACT

A carrier for an electrophotographic developer, in which a carrier core material surface is coated with a mixed resin of a fluorine resin selected from a tetrafluoroethylene-hexafluoropropylene copolymer or a tetrafluoroethylene-perfluoroalkyl vinyl ether copolymer, and a polyamide imide resin, wherein the mixed resin includes a surfactant and a charge control agent, and the mixed resin has a perfluorooctanoic acid content of 100 ppm or less and an electrophotographic developer using this carrier.

### BACKGROUND OF THE INVENTION

1. Field of the Invention

The present invention relates to a carrier for a two-component electrophotographic developer, and an electrophotographic developer using the carrier, used in copiers, printers and the like.

2. Description of the Related Art

Two-component electrophotographic developers used in electrophotographic methods are formed from a toner and a carrier. The carrier acts as a carrier substance that is mixed with the toner by stirring in a developing box to impart a desired charge to the toner and transport the charged toner to the surface of a photoreceptor to form an electrostatic latent image. Carrier remaining on the developing roll which is supported by magnets after forming the toner image returns back into the developing box, and is then mixed and stirred with new toner particles for reuse over a certain time period.

Unlike one-component electrophotographic developers, for these two-component electrophotographic developers, the carrier is stirred with the toner particles to impart desired charge properties to the toner particles and has a function of transporting the toner, and controllability in developer design is good. Therefore, two-component electrophotographic developers are especially widely used in full color developing machines for which high image quality is demanded and in high-speed machines for which the reliability and durability of image sustainability are demanded.

Thus, when used for a long period of time, the carrier particles must constantly frictionally charge the toner particles with a desired polarity and to a sufficient charge amount. However, fusion of the toner to the surface of the carrier particles, so-called “toner spent”, occurs due to collisions among the carrier particles, the mechanical stirring in the developer tank, or heated generated therefrom, so that the charge properties of the carrier particles deteriorate with usage time. As a result, since image deterioration, such as fogging and toner scattering, occurs, the whole developer has to be replaced.

To prevent such toner spent, conventionally, the life of the carrier has been extended by coating a low surface energy resin, for example, a silicone resin or a fluororesin, on the surface of the carrier core material.

However, in resin-coated carriers coated with a silicone resin, there is the problem that fogging and carrier beads carry over occur due to changes in the charge amount as a consequence of an increase in the temperature in the machine during continuous printing. Further, in resin-coated carriers coated with a fluoroepoxy resin, there is the problem that toner scattering and fogging occur due to a reduction in the charge amount caused by toner spent following printing. Moreover, the charge amount also decreases over time, and durability is poor. Further, when a fluoroepoxy resin is used, the solvent has to include an organic solvent which has a strong odor, such as methyl isobutyl ketone, so that in such case there is a problem with offensive odors during production.

Thus, it has been proposed to use a fluororesin as the coated resin. Japanese Patent Laid-Open No. 6-19214 discloses a carrier for a full color copying machine, in which the coated layer is formed from two layers, the lower coating material being a tetrafluoroethylene resin containing a polyamide imide resin, and the surface coating material being a tetrafluoroethylene-perfluoroalkyl vinyl ether copolymer.

Japanese Patent Laid-Open No. 55-67754 discloses a developer which uses a carrier having a core which is coated with a resin coating including 5 to 55% by weight of polytetrafluoroethylene, 5 to 55% by weight of fluorinated polyethylenepropylene, and a poly(amide-imide).

Further, Japanese Patent Laid-Open No. 54-126040 discloses a carrier material for an electrophotographic developer, which is provided on the surface of the carrier core material with a sheath layer formed from a material which includes a fluoropolymer, via an intermediate layer which includes a resin which has a lower melting point than the fluoropolymer and a larger dielectric constant. A polyamide resin and an ethylene-vinyl acetate resin are shown as an example of the intermediate layer.

Japanese Patent Laid-open No. 4-217270 discloses a carrier for electrophotography which is coated with at least one resin from a methyl-dimethyl silicone resin, a tetrafluoroethylene resin containing a polyamide imide resin, and a tetrafluoroethylene resin containing an epoxy resin.

Further, Japanese Patent Laid-Open No. 7-64344 discloses a carrier in which recessed portions on the surface of a porous, irregular shape, iron powder are filled with a polyamide imide resin or an epoxy resin, and a tetrafluoroethylene resin or a vinylidene fluoride resin, and the core material outer surface is coated with a silicone resin.

Japanese Patent Laid-Open No. 2005-99489 discloses a carrier for an electrophotographic developer comprising a magnetic powder having ferrite and/or magnetite as a main component, whose surface is coated with a mixed resin of a resin containing fluorine in the molecule, a resin having an amide bond in the molecule and/or a resin having two or more oxirane rings in one molecule.

Japanese Patent Laid-Open No. 2006-163373 proposes a resin-coated ferrite carrier for an electrophotographic developer in which the surface of ferrite particles is coated with a mixed resin of a tetrafluoroethylene-hexafluoropropylene copolymer or a tetrafluoroethylene-perfluoroalkyl vinyl ether copolymer and a polyamide imide resin, and in which the mixed resin contains a silicon oxide.

Thus, while various approaches using fluororesin coated carriers have been made, a carrier for an electrophotographic developer and an electrophotographic developer using such carrier are yet to be obtained which have, even in prolonged use, excellent charge stability and image stability over a long period of time, yet little fogging and carrier beads carry over, while also having good image density and environmental dependency.

### SUMMARY OF THE INVENTION

Therefore, it is an object of the present invention to provide a carrier for an electrophotographic developer and an electrophotographic developer using such carrier which resolve the above-described conventional problems, having excellent charge stability and image stability over a long period of time, yet little fogging and carrier beads carry over, while also having good image density and environmental dependency, and which are sufficiently capable of handling higher speeds and full color production.

As a result of investigations, the present inventors discovered that the above-described objects could be resolved by using a mixed resin of a specific fluororesin and a polyamide imide resin as the coated resin, including a surfactant and a charge control agent in the mixed resin, and setting the perfluorooctanoic acid content in the mixed resin to a fixed value or less, thereby arriving at the present invention.

Specifically, the present invention provides a carrier for an electrophotographic developer in which a carrier core material surface is coated with a mixed resin of a fluorine resin selected from a tetrafluoroethylene-hexafluoropropylene copolymer or a tetrafluoroethylene-perfluoroalkyl vinyl ether copolymer, and a polyamide imide resin, wherein the mixed resin includes a surfactant and a charge control agent, and the mixed resin has a perfluorooctanoic acid content of 100 ppm or less.

In the carrier for an electrophotographic developer of the present invention, the mixed weight ratio of the tetrafluoroethylene-hexafluoropropylene copolymer or tetrafluoroethylene-perfluoroalkylvinyl ether copolymer and the polyamide imide resin is 9:1 to 6:4.

In the carrier for an electrophotographic developer of the present invention, the surfactant is preferably a nonionic surfactant, and the mixed resin preferably has a surfactant content of 0.05 to 10% by weight.

In the carrier for an electrophotographic developer of the present invention, the charge control agent is preferably an amino silane coupling agent, and the mixed resin preferably has a charge control agent content of 0.05 to 15% by weight.

Further, the present invention provides an electrophotographic developer composed of the above-described carrier and a toner.

According to the present invention, a carrier for an electrophotographic developer and an electrophotographic developer using such carrier can be obtained, which have excellent charge stability and image stability over a long period of time, yet little fogging and carrier beads carry over, while also having good image density and environmental dependency, and which are sufficiently capable of handling higher speeds and full color production.

### DETAILED DESCRIPTION OF THE PREFERRED EMBODIMENTS

Preferred embodiments for carrying out the present invention will be now described.

### <Carrier for an Electrophotographic Developer According to the Present Invention>

The carrier for an elecrtrophotographic developer according to the present invention has a carrier core material surface which is coated with a mixed resin of a fluorine resin selected from a tetrafluoroethylene-hexafluoropropylene copolymer or a tetrafluoroethylene-perfluoroalkyl vinyl ether copolymer, and a polyamide imide resin.

Examples of the carrier core material used in the carrier for an electrophotographic developer according to the present invention include iron powder core materials, magnetite core materials, resin carrier core materials, and ferrite core materials which have conventionally been used as a carrier for an electrophotographic developer. Among these, especially preferred are ferrite core materials which include one kind selected from the group consisting of Mn, Mg, Li, Ca, Sr, and Ti. Considering the recent trend towards reducing environmental burden, such as restrictions on waste products, it is preferable for the heavy metals Cu, Zn, and Ni to be contained in an amount which does not exceed the scope of unavoidable impurities (accompanying impurities).

The average particle size of the carrier core material is preferably 20 to 70 μm. In this range, carrier beads carry over is prevented, and good image quality can be obtained. If the average particle size is less than 20 μm, carrier beads carry over tends to occur, and is thus not preferable. If the average particle size is more than 70 μm, image quality tends to deteriorate, and is thus not preferable.

### (Average Particle Size)

The average particle size was measured using a Microtrac Particle Size Analyzer (Model: 9320-X100), manufactured by Nikkiso Co., Ltd. Water was used for the dispersing solvent. A 100 mL beaker was charged with 10 g of a sample and 80 mL of water, and then 2 to 3 drops of a dispersant (sodium hexametaphosphate) were added therein. Next, using the ultrasonic homogenizer (Model: UH-150, manufactured by SMT Co. Ltd.), the output was set to level 4, and dispersing was carried out for 20 seconds. Then, the bubbles formed on the surface of the beaker were removed, and the sample was charged into the analyzer.

The tetrafluoroethylene-hexafluoropropylene copolymer (hereinafter sometimes referred to as “FEP”) used in the present invention is a fluororesin having a melting point of 250 to 270° C. Further, the tetrafluoroethylene-perfluoroalkylvinyl ether copolymer (hereinafter, sometimes referred to as “PFA”) used in the present invention is a fluororesin having a melting point of 300 to 310° C.

The polyamide imide resin used in the present invention is used as a binder resin. Therefore, although its production method, properties, etc. are not especially limited, a representative example is a copolymer of trimellitic anhydride and an organic bisamine, such as 4,4′-diaminodiphenylmethane. The average molecular weight of such a copolymer is representatively 15,000 to 30,000, and preferably 20,000 to 25,000. Further, a copolymer of pyromellitic anhydride and a bisamine, especially an aromatic bisamine, can be used. By using such a polyamide imide resin as a binder resin, high charging properties, stability against environmental changes in the machine, and good spent resistance are imparted to the developer.

The mixed weight ratio of the tetrafluoroethylene-hexafluoropropylene copolymer (FEP) or tetrafluoroethylene-perfluoroalkylvinyl ether copolymer (PFA) and the polyamide imide resin is preferably 9:1 to 6:4, and more preferably 8:2 to 6:4. In the mixed weight ratio of the FEP or PFA and the polyamide imide resin, if the mixed amount of the FEP or PFA is less than the above-described range, spent resistance and charge stability deteriorate, while if the mixed amount is more than the above-described range, durability is reduced.

The coated amount of the mixed resin is, based on the carrier core material, preferably 0.01 to 10% by weight, more preferably 0.3 to 7% by weight, and most preferably 0.5 to 5% by weight. If the coated amount is less than 0.01% by weight, it is difficult to form a uniform coated layer on the carrier surface. If the coated amount is more than 10% by weight, agglomerations form among the carrier particles, which becomes a factor in productivity decreases such as a decrease in yield, and fluctuation of the developer properties such as fluidity or charge amount in an actual machine.

In the present invention, a surfactant is included in the mixed resin as a coated resin. By including a surfactant, the dispersibility of the fluororesin improves, so that a uniform coating can be formed, and a sharper charge distribution can be obtained. In addition, the spent properties are improved, and even charge stability and image stability can be ensured for a long period of time.

Further, the surfactant is preferably a nonionic surfactant. Ionic or amphoteric surfactants have a large effect on the charge amount level, which makes it difficult to control to the correct charge amount level. Further, an ether-type surfactant is preferred as the nonionic surfactant. Examples of ether-type surfactants include, but are not limited to, polyoxyethylene alkyl ether, polyoxyethylene alkylphenyl ether, polyoxyethylene alkylallyl ether, and polyoxyethylene polyoxypropylene glycol.

The content of the surfactant is, based on the mixed resin, preferably 0.05 to 10% by weight. If the content of the surfactant is less than 0.05% by weight, the dispersibility of the fluororesin deteriorates, so that the coating becomes uneven, and the charge amount distribution and spent properties deteriorate. Further, if the content of the surfactant is more than 10% by weight, the stability of the charge amount from environmental changes deteriorates.

In the present invention, a charge control agent is included in the mixed resin as a coated resin. Examples of the charge control agent include various charge control agents and various silane coupling agents which are commonly used for toners. A charge control agent is included because, although charge imparting capability can decrease if a large amount of resin is coated, by adding the various charge control agents and silane coupling agents, the charge imparting capability can be controlled. The kind of charge control agent and silane coupling agent which can be used is not especially limited. Preferable examples of the charge control agent include a nigrosin dye, a quaternary ammonium salt, an organic metal complex and a metal-containing monoazo dye. Preferable examples of the silane coupling agent include an aminosilane coupling agent.

An aminosilane coupling agent is especially preferred. Typical aminosilane coupling agents can be represented by the following general formula.

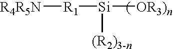

(wherein R₁ represents an alkylene group or a phenylene group having 1 to 4 carbon atoms, R₂ and R₃ represent an alkyl group having 1 or 2 carbon atoms, R₄ and R₅ represent a hydrogen atom, or a methyl group, an ethyl group, a phenyl group, an aminomethyl group, an aminoethyl group, or an aminophenyl group etc., and n=2 or 3)

Further, a primary amino silane coupling agent is preferred as the amino silane coupling agent. If the amino silane coupling agent used in the present invention has a secondary or a tertiary amino group included in the main chain, that secondary or tertiary amino group contributes almost nothing to the startup charge properties with a toner, and conversely, causes fluctuations in the charge properties during high humidity. For this reason, a primary amino silane coupling agent is preferred. The primary amino silane coupling agent can be represented by the following formula, and one example thereof is γ-aminopropylethoxysilane.

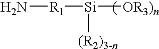

(wherein R₁ represents an alkylene group having 1 to 4 carbon atoms, R₂ and R₃ represent an alkyl group having 1 or 2 carbon atoms, and n=2 or 3)

The charge control agent content is, based on the mixed resin, preferably 0.05 to 15% by weight. If the charge control agent content is less than 0.05% by weight, the charge imparting capability is reduced, so that a stable image cannot be obtained. Further, if the charge control agent content is more than 15% by weight, the charge control agent in the coated resin is uneven, so that the stability of the charge amount is reduced and the durability of the coated resin is reduced.

In the present invention, the perfluorooctanoic acid content in the mixed resin is 100 ppm or less. If the perfluorooctanoic acid content is more than 100 ppm, the stability of the charge amount with respect to environmental change in the machine is markedly reduced. The perfluorooctanoic acid content is measured as follows.

### (Perfluorooctanoic Acid Content)

### (1) Pretreatment of a Sample and Preparation of a Sample Solution

A sample is adjusted to have a pH of 6 to 11 using 1 N hydrochloric acid or 1 N sodium hydroxide. A solid phase cartridge conditioned with 10 mL of methanol and 5 mL of purified water was set in a concentrator, and then 1 L of the sample was passed therethrough at 10 mL/min and extracted. The solid phase cartridge through which the sample had been passed was then dissolved with 2 mL of methanol, and the resultant mixture was charged into a 5 mL vessel. Nitrogen gas was blown thereon to obtain a 1 mL fixed volume, which was taken as the sample solution.

### (2) Measurement

Measurement was carried out by an LC/MS method under the following conditions.

### [HPLC Conditions]

Machine Model: Agilient 1100 (manufactured by Agilent)

### Column: Zorbax XDB C-18 (3.5 μm 2.1×150 mm)

Mobile Phase A: 10 μM ammonium acetate/acetonitrile (90:10)

### Mobile Phase B: Methanol/acetonitrile

Gradient: Started at 65% mobile phase A and 35% mobile phase B. This is changed by 2% per minute so that mobile phase A is 55% and mobile phase B is 45%. This state is then kept for 15 minutes. Next, the gradient is changed by 9% per minute so that mobile phase A is 10% and mobile phase B is 90%. This state is then kept for 5 minutes. The gradient is then changed by 11% per minute so that mobile phase A is 65% and mobile phase B is 35%. This state is then kept for 5 minutes.
Flow Rate: 0.2 mL/min

### Column Temperature: 40° C.

### Injection Amount: 10.0 μL

### [MS Conditions]

Machine Model: Agilient MSD SL (manufactured by Agilent)

### Capillary Voltage (Vcap): 4,000 v

Nebulizer: N₂ (50 psi)

### Drying Gas Flow Rate and Temperature: N₂ (10 L/min, 340° C.)

Ionization Method Electron spray ionization (ESI)
Measurement Mode: MRM mode
Monitor Ion: For PFOA determination 413 (m/z), for confirmation 369 (m/z)

### [Determination]

10 μL of the sample solution was charged into the LC/MS apparatus, and the PFOA concentration in the sample solution was measured from the peak surface area.

### [Calculation]

Calculation was carried out according to the following equation.

Calculated value: Cv (ng/L)

$$Cv = \frac{\{ \begin{matrix}Detected amount ( pg ) \times \\ Final liquid amount after solid phase extraction ( mL )\end{matrix} \}}{\{ LC / MS charged amount ( µL ) \times Analysis sample amount ( L ) \}}$$

Further, a conductive agent can be included in the mixed resin as a coated resin in order to control the electrical resistivity, charge amount, and charge speed of the carrier. Since the electrical resistivity of the conductive agent itself is low, there is a tendency for a sudden charge leak to occur if the content is too large. Therefore, the content is 0.25 to 20.0 by weight, preferably 0.5 to 15.0% by weight, and especially preferably 1.0 to 10.0% by weight, of the solid content of the mixed resin. Examples of the conductive agent include conductive carbon, oxides such as titanium oxide and tin oxide, and various organic conductive agents.

### <Electrophotographic Developer According to the Present Invention>

Next, the electrophotographic developer according to the present invention will be described.

The electrophotographic developer according to the present invention is composed of the above-described carrier for an electrophotographic developer and a toner.

Examples of the toner particles constituting the electrophotographic developer according to the present invention include pulverized toner particles produced by a pulverizing method, and polymerized toner particles produced by a polymerizing method. In the present invention, toner particles obtained by either method can be used.

The pulverized toner particles can be obtained, for example, by thoroughly mixing a binding resin, a charge control agent and a colorant by a mixer such as a Henschel mixer, then melting and kneading with a twin screw extruder or the like, cooling, pulverizing, classifying, adding with additives and then mixing with a mixer or the like.

The binding resin constituting the pulverized toner particle is not especially limited, and examples thereof include polystyrene, chloropolystyrene, styrene-chlorostyrene copolymer, styrene-acrylate copolymer and styrene-methacrylate copolymer, as well as a rosin-modified maleic acid resin, epoxide resin, polyester resin and polyurethane resin. These may be used alone or by being mixed together.

The used charge control agent can be arbitrarily selected. Examples of a positively-charged toner include a nigrosin dye and a quaternary ammonium salt, and examples of a negatively-charged toner include a metal-containing monoazo dye.

As the colorant (coloring material), conventionally known dyes and pigments can be used. Examples include carbon black, phthalocyanine blue, permanent red, chrome yellow, phthalocyanine green. In addition, additives such as a silica powder and titania for improving the fluidity and cohesion resistance of the toner can be added according to the toner particles.

Polymerized toner particles are produced by a conventionally known method such as suspension polymerization, emulsion polymerization, emulsion coagulation, ester extension polymerization and phase transition emulsion. The polymerization method toner particles can be obtained, for example, by mixing and stirring a colored dispersion liquid in which a colorant is dispersed in water using a surfactant, a polymerizable monomer, a surfactant and a polymerization initiator in an aqueous medium, emulsifying and dispersing the polymerizable monomer in the aqueous medium, and polymerizing while stirring and mixing. Then, the polymerized dispersion is charged with a salting-out agent, and the polymerized particles are salted out. The particles obtained by the salting-out are filtrated, washed and dried to obtain the polymerized toner particles. Subsequently, an additive is optionally added to the dried toner particles.

Further, during the production of the polymerized toner particles, a fixation improving agent and a charge control agent can be blended in addition to the polymerizable monomer, surfactant, polymerization initiator and colorant, thereby allowing the various properties of the polymerized toner particles to be controlled and improved. A chain-transfer agent can also be used to improve the dispersibility of the polymerizable monomer in the aqueous medium and to adjust the molecular weight of the obtained polymer.

The polymerizable monomer used in the production of the above-described polymerized toner particles is not especially limited, and examples thereof include styrene and its derivatives, ethylenic unsaturated monoolefins such as ethylene and propylene, halogenated vinyls such as vinyl chloride, vinyl esters such as vinyl acetate, and α-methylene fatly monocarboxylates, such as methyl acrylate, ethyl acrylate, methyl methacrylate, ethyl methacrylate, 2-ethylhexyl methacrylate, dimethylamino acrylate and diethylamino methacrylate.

As the colorant (coloring material) used for preparing the above polymerized toner particles, conventionally known dyes and pigments are usable. Examples include carbon black, phthalocyanine blue, permanent red, chrome yellow and phthalocyanine green. The surface of colorants may be improved by using a silane coupling agent, a titanium coupling agent and the like.

As the surfactant used for the production of the above polymerized toner particle, an anionic surfactant, a cationic surfactant, an amphoteric surfactant and a nonionic surfactant can be used.

Here, examples of anionic surfactants include sodium oleate, a fatty acid salt such as castor oil, an alkyl sulfate such as sodium lauryl sulfate and ammonium lauryl sulfate, an alkylbenzene sulfonate such as sodium dodecylbenzene sulfonate, an alkylnaphthalene sulfonate, an alkylphosphate, a naphthalenesulfonic acid-formalin condensate and a polyoxyethylene alkyl sulfate. Examples of nonionic surfactants include a polyoxyethylene alkyl ether, a polyoxyethylene fatly acid ester, a sorbitan fatly acid ester, a polyoxyethylene alkyl amine, glycerin, a fatly acid ester and an oxyethylene-oxypropylene block polymer. Further, examples of cationic surfactants include alkylamine salts such as laurylamine acetate, and quaternary ammonium salts such as lauryltrimethylammonium chloride and stearyltrimethylammonium chloride. In addition, examples of amphoteric surfactants include an aminocarbonate and an alkylamino acid.

The above-described surfactant can normally be used in an amount within the range of 0.01 to 10% by weight based on the polymerizable monomer. Such a used amount of the surfactant has an effect on the dispersion stability of the monomer, and also has an effect on the environmental dependency of the obtained polymerized toner particles. Therefore, it is preferred to use in the above-described range in which the dispersion stability of the monomer can be ensured, and in which it is difficult to cause an excessive effect on the environmental dependency of the obtained polymerized toner particles.

For the production of the polymerized toner particles, a polymerization initiator is generally used. Examples of polymerization initiators include water-soluble polymerization initiators and oil-soluble polymerization initiators, and either of them can be used in the present invention. Examples of water-soluble polymerization initiators which can be used in the present invention include persulfate salts such as potassium persulfate and ammonium persulfate, and water-soluble peroxide compounds. Examples of oil-soluble polymerization initiator include azo compounds such as azobisisobutyronitrile, and oil-soluble peroxide compounds.

In the case where a chain-transfer agent is used in the present invention, examples of the chain-transfer agent include mercaptans such as octylmercaptan, dodecylmercaptan and tert-dodecylmercaptan and carbon tetrabromide.

Further, in the case where the polymerized toner particles used in the present invention contain a fixation improving agent, examples of such fixation improving agent include a natural wax such as carnauba wax, and an olefinic wax such as polypropylene and polyethylene.

In the case where the polymerized toner particles used in the present invention contain a charge control agent, the charge control agent which is used is not especially limited. Examples include a nigrosine dye, a quaternary ammonium salt, an organic metal complex and a metal-containing monoazo dye.

Examples of the additive used for improving the fluidity etc. of the polymerized toner particles include silica, titanium oxide, barium titanate, fluorine resin microparticles and acrylic resin microparticles. These can be used alone or in combination thereof.

Further, examples of the salting-out agent used for separating the polymerized particles from the aqueous medium include metal salts such as magnesium sulfate, aluminum sulfate, barium chloride, magnesium chloride, calcium chloride and sodium chloride.

The average particle size of the toner particles produced as above is in the range of 2 to 15 μm, and preferably in the range of 3 to 10 μm. Polymerized toner particles have higher uniformity than pulverized toner particles. If the toner particles are less than 2 μm, charging capability is reduced, whereby fogging and toner scattering tend to occur. If the toner particles are more than 15 μm, this becomes a factor in deteriorating image quality.

By mixing the thus-produced carrier with a toner, an electrophotographic developer can be obtained. The mixing ratio of the carrier to the toner, namely, the toner concentration, is preferably set to be 3 to 15%. If the concentration is less than 3%, a desired image density is hard to obtain. If the concentration is more than 15%, toner scattering and fogging tend to occur.

The thus-prepared electrophotographic developer according to the present invention can be used in digital copying machines, printers, FAXs, printing presses and the like, which use a development system in which electrostatic latent images formed on a latent image holder having an organic photoconductor layer are reversal-developed by the magnetic brushes of a two-component developer having the toner and the carrier while impressing a bias electric field. The present developer can also be applied in full-color machines and the like which use an alternating electric field, which is a method that superimposes an AC bias on a DC bias, when the developing bias is applied from magnetic brushes to the electrostatic latent image side.

The present invention will now be described in more detail based on the following examples.

### Example 1

Respective raw materials were appropriately weighed in a ratio of 39.7 mol % in terms of MnO, 9.9 mol % in terms of MgO, 49.6 mol % in terms of Fe₂O₃, and 0.8 mol % in terms of SrO. The mixture was charged with water and crushed and mixed for 10 hours by a wet ball mill. The resultant slurry was dried, held for 4 hours at 950° C., and then crushed for 24 hours by a wet ball mill. The slurry was granulated and dried, and held for 6 hours at 1,270° C. in an atmosphere having an oxygen concentration of 2%. After crushing, the granulated material was classified for particle size adjustment to obtain Mn—Mg—Sr ferrite particles (carrier core material). These ferrite particles had an average particle size of 35 μm, and a saturated magnetization of 70 Am²/kg under an applied magnetic field of 3,000 (10³/4π·A/m).

Next, a polyamide imide resin (copolymer of trimellitic anhydride and 4,4′-diaminodiphenylmethane) was diluted with water to prepare a resin solution. Then, a tetrafluoroethylene-perfluorovinyl ether copolymer (PFA), which had a perfluorooctanoic acid content of 3 ppm, and polyoxyethylene alkyl ether, which is a nonionic surfactant, were dispersed in the resin solution. The dispersion amount of the nonionic surfactant polyoxyethylene alkyl ether is 2% by weight in terms of resin solid content. Further, 5% by weight in terms of the resin solid content of an amino silane coupling agent (Trade name: KBM-603, manufactured by Shin-Etsu Chemical Co., Ltd.) was dispersed to obtain 200 g in terms of solid content of a coated layer forming solution. The solid content of the resin solution at this stage was 10% by weight. The weight composition ratio of the polyamide imide resin and the PFA at this stage was 2/8. This coated layer forming solution and 10 kg of the above-described ferrite particles were charged into a fluidized bed coater to carry out coating. Then, the coated ferrite particles were baked for 1 hour at 250° C. to produce a resin-coated ferrite carrier 1 having a resin coated content of 2% by weight.

The carrier 1 and the commercially-available imagio MPC 2500 magenta toner manufactured by Ricoh Company Ltd. were weighed under a 25° C., 55% RH environment so as to produce 1 kg of a developer amount having a toner concentration of 8% by weight. This developer was exposed for 12 hours under the above-described conditions, and then stirred for 30 minutes with the stirring device Turbula Mixer T2C model manufactured by Turbula Co., Ltd. (stirring speed: 96 rpm) to obtain an initial NN developer 1. As shown in Table 2, the charge amount of this developer was measured as 18.5 μC/g.

Further, this initial NN developer 1 was mounted on an imagio MPC 2500 manufactured by Ricoh Company Ltd., and a 50,000 sheet printing test was carried out. As shown in Table 2, the charge amount of a developer 2 after the printing of 50,000 sheets was 19.4 μC/g. As shown by the charge stability of 105%, almost no charge fluctuation was observed. Further, the charge amount environmental difference was 18%, meaning that the difference between the charge amount under a high-temperature, high-humidity environment and the charge amount under a low-temperature, low-humidity environment was very small. In addition, as shown in Table 2, the spent amount resulting from printing 50,000 sheets was 0.04%, meaning that toner adhesion was very low.

The measurement methods for the charge amount, charge amount distribution, charge amount stability, charge amount environmental difference, and spent amount are shown below.

### (Charge Properties)

The charge amount was determined by measuring with a suction type charge measurement device, Epping q/m-meter, manufactured by Epping PES-Laboratorium (mesh: 635 mesh, suction pressure: 105±10 mbar, suction time 90 seconds).

### (Charge Amount Distribution)

The charge amount distribution was determined by measuring under the following conditions with N=3 using the q-test manufactured by Epping PES-Laboratorium, and taking the average value of the overall standard deviation [fC/10 μm].

### Mesh Size (Mesh) 635

Toner Flow Rate [mL/min]: 160

### Electrode Voltage [V]: 4,000

### Cell AC Voltage [V]: Off

### Cell AC Frequency [Hz]: Off

### Cell DC Voltage [V]: Off

### (Charge Amount Stability)

The charge amount stability was calculated from the following formula using the charge amount of the above-obtained initial NN developer 1 after 30 minutes of stirring and the charge amount of the developer 2 after the printing of 50,000 sheets. Here, the closer the charge amount stability value is to 100%, the smaller the change that is indicated in durability A value of 100% indicates that there is no change in durability

$$Charge Amount Stability ( \% ) = \frac{( Charge Amount of the Developer 2 After Printing )}{( Charge Amount of the Initial NN Developer 1 )} \times 100$$

### (Charge Amount Environmental Difference)

The carrier 1 and the commercially-available imagio MPC 2500 magenta toner manufactured by Ricoh Company Ltd. were weighed under a 30° C., 85% RH environment so as to produce 1 kg of a developer amount having a toner concentration of 8% by weight. This developer was exposed for 12 hours under the above-described conditions, and then stirred for 30 minutes with the stirring device Turbula Mixer T2C model manufactured by Turbula Co., Ltd. (stirring speed: 96 rpm) to obtain an initial HH developer 3. Further, an initial LL developer 4 was obtained in the same order, except that the environmental conditions were changed to 10° C. and 20% RH. The charge amount environmental difference between these developers was calculated from the following formula using the charge amount of the initial HH developer 3 and the charge amount initial developer 4. Here, the closer the charge amount environmental difference is to 0%, the less the change that is indicated in the environmental fluctuation of the charge amounts between the high-temperature, high-humidity conditions and the low-temperature, low-humidity conditions.

### Charge Amount Environmental Difference: CAED (%)

$$C A E D = \frac{( Initial LL Developer 4 ) - ( Initial HH Developer 3 )}{Initial LL Developer 4} \times 100$$

### (Spent Amount)

Toner was removed by suction from the developer after printing using a 635 mesh wire, and the carrier after printing was extracted. Then, the spent amount was calculated by measuring the carbon content in the carrier and the carrier after printing using a carbon analyzer C-200 Model manufactured by LECO Corporation (Oxygen gas pressure: 2.5 kg/cm², nitrogen gas pressure: 2.8 kg/cm²).

$$Spent Amout ( \% ) = \frac{A}{Carbon Content of the Carrier} \times 100$$

A=(Carbon Content of Carrier After Printing)−(Carbon Content of the Carrier)

### Example 2

A carrier for an electrophotographic developer was produced by the same steps as in Example 1, except that, as shown in Table 1, the added amount of the amino silane coupling agent was 15% by weight.

### Example 3

A carrier for an electrophotographic developer was produced by the same steps as in Example 1, except that, as shown in Table 1, the surfactant was polyoxyethylene alkylphenyl ether, which is a nonionic surfactant, and the added amount of the amino silane coupling agent was 0.05% by weight.

### Example 4

A carrier for an electrophotographic developer was produced by the same steps as in Example 1, except that, as shown in Table 1, the surfactant was glycerin fatty acid ester, which is a nonionic surfactant, and the added amount thereof was 0.05% by weight.

### Example 5

A carrier for an electrophotographic developer was produced by the same steps as in Example 3, except that, as shown in Table 1, the added amount of the surfactant was 10% by weight, and the added amount of the amino silane coupling agent was 5% by weight.

### Example 6

A carrier for an electrophotographic developer was produced by the same steps as in Example 3, except that, as shown in Table 1, the charge control agent was a quaternary ammonium (trade name: BONTRON P-51, manufactured by Orient Chemical Industries, Ltd.), and the added amount thereof was 5% by weight.

### Example 7

A carrier for an electrophotographic developer was produced by the same steps as in Example 1, except that, as shown in Table 1, the fluorine resin was a tetrafluoroethylene-perfluorovinyl ether copolymer (PFA) which had a perfluorooctanoic acid content of 42 ppm, and the surfactant was an alkyltrimethyl ammonium salt, which is a cationic surfactant.

### Example 8

A carrier for an electrophotographic developer was produced by the same steps as in Example 7, except that, as shown in Table 1, the surfactant was sodium alkyl sulfate, which is a anionic surfactant.

### Example 9

A carrier for an electrophotographic developer was produced by the same steps as in Example 7, except that, as shown in Table 1, the surfactant was an alkyl amine oxide, which is an amphoteric surfactant.

### Example 10

A carrier for an electrophotographic developer was produced by the same steps as in Example 7, except that, as shown in Table 1, the surfactant was the nonionic surfactant polyoxyethylene alkyl ether, and the added amount thereof was 11% by weight.

### Example 11

A carrier for an electrophotographic developer was produced by the same steps as in Example 1, except that, as shown in Table 1, the added amount of the amino silane coupling agent was 17.5% by weight.

### Example 12

A carrier for an electrophotographic developer was produced by the same steps as in Example 1, except that, as shown in Table 1, the fluorine resin was a tetrafluoroethylene-hexafluoropropylene copolymer (FEP) which had a perfluorooctanoic acid content of 100 ppm.

### Comparative Example 1

A carrier for an electrophotographic developer was produced by the same steps as in Example 1, except that, as shown in Table 1, the fluorine resin was a tetrafluoroethylene-hexafluoropropylene copolymer (FEP) which had a perfluorooctanoic acid content of 140 ppm.

### Comparative Example 2

A carrier for an electrophotographic developer was produced by the same steps as in Example 1, except that, as shown in Table 1, a surfactant was not used.

### Comparative Example 3

A carrier for an electrophotographic developer was produced by the same steps as in Example 1, except that, as shown in Table 1, a charge control agent was not used.

Table 1 shows the carrier compositions of Examples 1 to 12 and Comparative Examples 1 to 3. Further, Table 2 shows the carrier properties (initial NN developer charge amount, initial LL developer charge amount, initial HH developer charge amount, developer charge amount after printing, charge amount stability, charge amount distribution, charge amount environmental difference, carrier carbon content, carrier carbon content after printing, and the spent amount).

TABLE 1

| | Carrier Composition | | | | | | | | |
|---|---|---|---|---|---|---|---|---|---|
| | | | | Coated | Perfluoro- | | | | Charge Control |
| | Core Material | Fluorine | Fluorine | Amount | octanoic | | Surfactant | Charge | Agent Added |
| | Average | Resin | Resin | (% by | Acid Content | | Added Amount | Control | Amount (% |
| | Particle Size | Kind | Ratio | weight) | (ppm) | Surfactant Kind | (% by weight) | Agent Kind | by weight) |
| Example 1 | Mn—Mg—Sr | PFA | 80% | 2 | 3 | Nonionic Surfactant | 2.00 | Amino Silane | 5.00 |
| | 35 μm | | | | | (polyoxyethylene | | Coupling | |
| | | | | | | alkyl ether) | | Agent *1 | |
| Example 2 | Mn—Mg—Sr | PFA | 80% | 2 | 3 | Nonionic Surfactant | 2.00 | Amino Silane | 15.00 |
| | 35 μm | | | | | (polyoxyethylene | | Coupling | |
| | | | | | | alkyl ether) | | Agent *1 | |
| Example 3 | Mn—Mg—Sr | PFA | 80% | 2 | 3 | Nonionic Surfactant | 2.00 | Amino Silane | 0.05 |
| | 35 μm | | | | | (polyoxyethylene | | Coupling | |
| | | | | | | alkylphenyl | | Agent *1 | |
| | | | | | | ether) | | | |
| Example 4 | Mn—Mg—Sr | PFA | 80% | 2 | 3 | Nonionic Surfactant | 0.05 | Amino Silane | 5.00 |
| | 35 μm | | | | | (glycerin | | Coupling | |
| | | | | | | fatty acid ether) | | Agent *1 | |
| Example 5 | Mn—Mg—Sr | PFA | 80% | 2 | 3 | Nonionic Surfactant | 10.00 | Amino Silane | 5.00 |
| | 35 μm | | | | | (polyoxyethylene | | Coupling | |
| | | | | | | alkylphenyl | | Agent *1 | |
| | | | | | | ether) | | | |
| Example 6 | Mn—Mg—Sr | PFA | 80% | 2 | 3 | Nonionic Surfactant | 2.00 | Quaternary | 5.00 |
| | 35 μm | | | | | (polyoxyethylene | | Ammonium | |
| | | | | | | alkylphenyl | | Salt *2 | |
| | | | | | | ether) | | | |
| Example 7 | Mn—Mg—Sr | PFA | 80% | 2 | 42 | Cationic Surfactant | 2.00 | Amino Silane | 5.00 |
| | 35 μm | | | | | (alkyltrimethyl | | Coupling | |
| | | | | | | ammonium salt) | | Agent *1 | |
| Example 8 | Mn—Mg—Sr | PFA | 80% | 2 | 42 | Anionic Surfactant | 2.00 | Amino Silane | 5.00 |
| | 35 μm | | | | | (sodium | | Coupling | |
| | | | | | | alkyl sulfate) | | Agent *1 | |
| Example 9 | Mn—Mg—Sr | PFA | 80% | 2 | 42 | Amphoteric | 2.00 | Amino Silane | 5.00 |
| | 35 μm | | | | | Surfactant (alkyl | | Coupling | |
| | | | | | | amine oxide) | | Agent *1 | |
| Example 10 | Mn—Mg—Sr | PFA | 80% | 2 | 42 | Nonionic Surfactant | 11.00 | Amino Silane | 5.00 |
| | 35 μm | | | | | (polyoxyethylene | | Coupling | |
| | | | | | | alkyl ether) | | Agent *1 | |
| Example 11 | Mn—Mg—Sr | PFA | 80% | 2 | 42 | Nonionic Surfactant | 2.00 | Amino Silane | 17.50 |
| | 35 μm | | | | | (polyoxyethylene | | Coupling | |
| | | | | | | alkyl ether) | | Agent *1 | |
| Example 12 | Mn—Mg—Sr | FEP | 80% | 2 | 100 | Nonionic Surfactant | 2.00 | Amino Silane | 5.00 |
| | 35 μm | | | | | (polyoxyethylene | | Coupling | |
| | | | | | | alkyl ether) | | Agent *1 | |
| Comparative | Mn—Mg—Sr | FEP | 80% | 2 | 140 | Nonionic Surfactant | 2.00 | Amino Silane | 5.00 |
| Example 1 | 35 μm | | | | | (polyoxyethylene | | Coupling | |
| | | | | | | alkyl ether) | | Agent *1 | |
| Comparative | Mn—Mg—Sr | PFA | 80% | 2 | 3 | None | 0.00 | Amino Silane | 5.00 |
| Example 2 | 35 μm | | | | | | | Coupling | |
| | | | | | | | | Agent *1 | |
| Comparative | Mn—Mg—Sr | PFA | 80% | 2 | 3 | Nonionic Surfactant | 2.00 | None | 0.00 |
| Example 3 | 35 μm | | | | | (polyoxyethylene | | | |
| | | | | | | alkyl ether) | | | |

*1: Trade name: KBM-603, manufactured by Shin-Etsu Chemical Co., Ltd.
*2: Trade name: BONTRON P-51, manufactured by Orient Chemical Industries, Ltd.

TABLE 2

| | Evaluation Properties | | | | | | | | | |
|---|---|---|---|---|---|---|---|---|---|---|
| | Initial NN | Initial LL | Initial HH | | | | | | | |
| | Developer | Developer | Developer | Developer | Charge | Charge | Charge | Carrier | Carrier | |
| | Charge | Charge | Charge | Charge Amount | Amount | Amount | Amount | Carbon | Carbon Content | Spent |
| | Amount | Amount | Amount | After Printing | Stability | Distribution | Environmental | Content | After Printing | Amount |
| | (μC/g) | (μC/g) | (μC/g) | (μC/g) | (%) | (%) | Difference (%) | (%) | (%) | (%) |
| Example 1 | 18.5 | 20.5 | 16.8 | 19.4 | 105 | 2.26 | 18 | 0.76 | 0.80 | 0.04 |
| Example 2 | 14.0 | 15.8 | 11.7 | 16.6 | 119 | 2.51 | 26 | 0.77 | 0.83 | 0.06 |
| Example 3 | 24.0 | 26.8 | 20.5 | 26.3 | 110 | 1.95 | 24 | 0.74 | 0.79 | 0.05 |
| Example 4 | 17.9 | 19.8 | 15.8 | 16.5 | 92 | 2.89 | 20 | 0.73 | 0.82 | 0.09 |
| Example 5 | 18.2 | 20.5 | 14.5 | 20.5 | 113 | 1.88 | 29 | 0.79 | 0.82 | 0.03 |
| Example 6 | 15.9 | 16.8 | 12.5 | 14.1 | 89 | 2.34 | 26 | 0.75 | 0.79 | 0.04 |
| Example 7 | 10.4 | 14.5 | 9.5 | 6.8 | 65 | 3.53 | 34 | 0.69 | 0.79 | 0.10 |
| Example 8 | 24.8 | 27.9 | 23.8 | 30.0 | 121 | 3.02 | 15 | 0.68 | 0.78 | 0.10 |
| Example 9 | 11.6 | 14.2 | 8.8 | 8.5 | 73 | 3.24 | 38 | 0.68 | 0.77 | 0.09 |
| Example 10 | 20.5 | 28.4 | 19.0 | 21.6 | 105 | 1.93 | 33 | 0.82 | 0.85 | 0.03 |
| Example 11 | 11.4 | 13.7 | 10.4 | 12.1 | 106 | 3.16 | 24 | 0.83 | 0.87 | 0.04 |
| Example 12 | 19.0 | 24.0 | 14.0 | 21.2 | 112 | 2.31 | 42 | 0.76 | 0.81 | 0.05 |
| Comparative | 20.4 | 35.6 | 14.2 | 22.5 | 110 | 2.01 | 60 | 0.72 | 0.81 | 0.09 |
| Example 1 | | | | | | | | | | |
| Comparative | 16.1 | 19.5 | 14.2 | 9.5 | 59 | 6.09 | 27 | 0.69 | 0.86 | 0.17 |
| Example 2 | | | | | | | | | | |
| Comparative | 25.7 | 28.2 | 20.8 | 35.3 | 137 | 1.98 | 26 | 0.74 | 0.80 | 0.06 |
| Example 3 | | | | | | | | | | |

As is clear from Table 2, in Examples 1 to 12 good results were obtained for all of charge amount stability, charge amount distribution, and charge amount environmental difference. Further, the spent amount over time was also low. In contrast, Comparative Example 1, which contained a large amount of perfluorooctanoic acid, had a large charge amount environmental difference. Comparative Example 2, which did not contain a surfactant had poor charge amount stability and charge amount distribution, while the spent amount over time was also large. Comparative Example 3, which did not contain a charge control agent had too high an initial NN charge amount and poor charge amount stability.

By using the carrier for an electrophotographic developer according to the present invention, charge stability and image stability are excellent over a long period of time, yet little fogging and carrier beads carry over, while image density and environmental dependency are also good.

Therefore, the carrier for an electrophotographic developer according to the present invention, and electrophotographic developer using this, can be used in a wide range of fields, such as full color developing machines in which high image quality is demanded, and high-speed machines in which the reliability and durability of image sustainability are demanded.

1. A carrier for an electrophotographic developer in which a carrier core material surface is coated with a mixed resin of a fluorine resin selected from a tetrafluoroethylene-hexafluoropropylene copolymer or a tetrafluoroethylene-perfluoroalkyl vinyl ether copolymer, and a polyamide imide resin, wherein the mixed resin comprises a surfactant and a charge control agent, and the mixed resin has a perfluorooctanoic acid content of 100 ppm or less.

2. The carrier for an electrophotographic developer according to claim 1, the mixed weight ratio of the tetrafluoroethylene-hexafluoropropylene copolymer or tetrafluoroethylene-perfluoroalkylvinyl ether copolymer and the polyamide imide resin is 9:1 to 6:4.

3. The carrier for an electrophotographic developer according to claim 1, wherein the surfactant is a nonionic surfactant.

4. The carrier for an electrophotographic developer according to claim 1, the charge control agent is an amino silane coupling agent.

5. The carrier for an electrophotographic developer according to claim 1, wherein the mixed resin has a surfactant content of 0.05 to 10% by weight.

6. The carrier for an electrophotographic developer according to claim 1, wherein the mixed resin has a charge control agent content of 0.05 to 15% by weight.

7. An electrophotographic developer comprising the carrier for an electrophotographic developer according to claim 1 and a toner.

8. An electrophotographic developer comprising the carrier for an electrophotographic developer according to claim 2 and a toner.

9. An electrophotographic developer comprising the carrier for an electrophotographic developer according to claim 3 and a toner.

10. An electrophotographic developer comprising the carrier for an electrophotographic developer according to claim 4 and a toner.

11. An electrophotographic developer comprising the carrier for an electrophotographic developer according to claim 5 and a toner.

12. An electrophotographic developer comprising the carrier for an electrophotographic developer according to claim 6 and a toner.
